(19) United States
(12) Patent Application Publication
(10) Pub. No.: US 2005/0040136 A1
(43) Pub. Date: Feb. 24, 2005

(54) Method for making memory elements

(76) Inventors: Yao-Sheng Lee, Tampa, FL (US); Mike DeVre, Safety Harbor, FL (US)

Correspondence Address: Harvey S. Kauget;Holland & Knight LLP, Suite 4100, 100 N. Tampa Street, Tampa, FL, 33602-3644, US

(21) Appl. No.: 10/895,277

(22) Filed: Jul. 20, 2004

Related U.S. Application Data
(60) Provisional application No. 60/488,921, filed on Jul. 21, 2003.

(51) Int. Cl. B44C 1/22

(52) U.S. Cl. 216/22

(57) ABSTRACT

The present invention provides an improved method for forming a memory element having a chalcogenide layer such as Ge₂Sb₂Te₅. A substrate having a dielectric etch stop layer, a chalcogenide layer, an anti-reflective layer and a mask layer is placed in a vacuum chamber having a high density plasma source. At least one chlorine containing gas, such as a mixture of BCl₃ and Cl₂, is introduced into the vacuum chamber for etching the chalcogenide layer and the anti-reflective layer to the dielectric etch stop layer. The etch process is discontinued based on an endpoint detection system. Upon completion of the etch process, the substrate is removed from the vacuum chamber and the mask layer is stripped from the substrate.

### CROSS REFERENCES TO RELATED APPLICATIONS

This application claims priority from and is related to commonly owned U.S. Provisional Patent Application Ser. No. 60/488,921 filed Jul. 21, 2003, entitled: Plasma Etching of GeSbTe Films, this Provisional Patent Application incorporated by reference herein.

### FIELD OF THE INVENTION

The present invention relates generally to the field of semiconductor devices and fabrication. More particularly, the present invention relates to memory elements and methods for making memory elements.

### BACKGROUND OF THE INVENTION

Chalcogenide material alloys have the ability to convert between amorphous and crystalline phases through the application of temperature. The phase change alters both the electrical and optical properties of the material. Recently these materials have been incorporated into non-volatile memory devices such as Ovonic Unified Memory (OUM).

A common chalcogenide used for the manufacture of OUM is GeₓSb_{y}Te_{z} (GST) where typical values are x=2, y=2 and z=5). Chalcogenide materials may be switched between numerous electrically detectable conditions of varying resistivity in nanosecond time periods with the input of picojoules of energy. The operation of chalcogenide memory cells requires that a region of the chalcogenide memory material, known as the active region, be subjected to a current pulse to change the crystalline state of the chalcogenide material within the active region. Typically, a current density of between about 10⁵ and 10⁷ amperes/cm² is needed. To obtain this current density in a commercially viable device, the active region of each memory cell should be made as small as possible to minimize the total current drawn by the memory device.

The state of the art for etching GST films is to employ ion milling. See Klersey (U.S. Patent Application Number 2003/0075778) which describes the etching of GST films using ion milling. While ion milling results in anisotropically etched features, this process results in nonvolatile etch products that may redeposit on device surfaces. As a result, the small features required for GST OUM devices will have a poor yield.

To increase the yield of GST OUM devices, operating parameters for the etching step of the GST film need be specified such that the process can be implemented as a production worthy process (e.g., no unattainable or uncontrollable parameter values required) while reducing nonvolatile etch product.

Therefore, there is a need for a process that etches GST anisotropically at controllable etch rates with selectivity to both the etch mask and the etch stop layer while reducing nonvolatile etch product.

Nothing in the prior art provides the benefits attendant with the present invention.

Therefore, it is an object of the present invention to provide an improvement which overcomes the inadequacies of the prior art devices and which is a significant contribution to the advancement of the semiconductor processing art.

Another object of the present invention is to provide an improved method for forming a memory element, the method comprising the steps of: placing a substrate in a vacuum chamber, said substrate having a dielectric etch stop layer, a chalcogenide layer, an anti-reflective layer and a mask layer; introducing at least one chlorine containing gas into the vacuum chamber; igniting a high density plasma in the vacuum chamber; etching said chalcogenide layer and said anti-reflective layer to expose said dielectric etch stop layer on said substrate; removing said substrate from the vacuum chamber; and stripping said mask layer from said substrate.

Yet another object of the present invention is to provide an improved method for forming a memory element, the method comprising the steps of: placing a substrate in a vacuum chamber, said substrate having a dielectric etch stop layer, a chalcogenide layer, an anti-reflective layer and a mask layer; introducing at least one chlorine containing gas into the vacuum chamber; igniting a high density plasma in the vacuum chamber; etching said chalcogenide layer and said anti-reflective layer to expose said dielectric etch stop layer on said substrate; discontinuing the etching step based on an endpoint detection system; removing said substrate from the vacuum chamber; and stripping said mask layer from said substrate.

The foregoing has outlined some of the pertinent objects of the present invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by. the claims taken in conjunction with the accompanying drawings.

### SUMMARY OF THE INVENTION

For the purpose of summarizing this invention, this invention comprises an improved method for etching a chalcogenide layer such as Ge₂Sb₂Te₅ (GST) in the formation of memory devices such as Ovonic Unified Memory (OUM).

A feature of the present invention is to provide an improved method for forming a memory element. The method comprising the following steps. A substrate is placed in a vacuum chamber. The substrate can be a semiconductor substrate such as Silicon, Gallium Arsenide or any known semiconductor, including compound semiconductors e.g., Group II and Group VI compounds and Group III and Group V compounds. The substrate can be placed on a substrate support in the vacuum chamber. The substrate support can be a lower electrode for producing an electric field within the vacuum chamber. The substrate has a dielectric etch stop layer, a chalcogenide layer, an anti-reflective layer and a mask layer. The chalcogenide layer can be a film of GeₓSb_{y}Te_{z} where the ratios are Ge₂Sb₂Te₅. At least one chlorine containing gas, such as a mixture of BCl₃ and Cl₂, is introduced into the vacuum chamber for etching the chalcogenide layer and the anti-reflective layer through a high density plasma that is ignited from the chlorine containing gas in the vacuum chamber. In addition, a hydrogen containing gas and/or an oxygen scavenger gas can be introduced into the vacuum chamber to form a plasma for etching the substrate. The high density plasma is generated by a high density plasma source such as an inductively coupled plasma source operating at a frequency of about 2 MHz. The chalcogenide layer and the anti-reflective layer are etched to expose the dielectric etch stop layer on the substrate. A bias can be supplied to the substrate through the substrate holder within the vacuum chamber. The RF bias can operate at a frequency of about 13.56 MHz. Upon completion of the etch process, the substrate is removed from the vacuum chamber and the mask layer is stripped from the substrate.

Another feature of the present invention is to provide an improved method for forming a memory element. The method comprising the following steps. A substrate is placed in a vacuum chamber. The substrate can be a semiconductor substrate such as Silicon, Gallium Arsenide or any known semiconductor, including compound semiconductors e.g., Group II and Group VI compounds and Group III and Group V compounds. The substrate can be placed on a substrate support in the vacuum chamber. The substrate support can be a lower electrode for producing an electric field within the vacuum chamber. The substrate has a dielectric etch stop layer, a chalcogenide layer, an anti-reflective layer and a mask layer. The chalcogenide layer can be a film of GeₓSb_{y}Te_{z} where the ratios are Ge₂Sb₂Te₅. At least one chlorine containing gas, such as a mixture of BCl₃ and Cl₂, is introduced into the vacuum chamber for etching the chalcogenide layer and the anti-reflective layer through a high density plasma that is ignited from the chlorine containing gas in the vacuum chamber. In addition, a hydrogen containing gas and/or an oxygen scavenger gas can be introduced into the vacuum chamber to form a plasma for etching the substrate. The high density plasma is generated by a high density plasma source such as an inductively coupled plasma source operating at a frequency of about 2 MHz. The chalcogenide layer and the anti-reflective layer are etched to expose the dielectric etch stop layer on the substrate. A bias can be supplied to the substrate through the substrate holder within the vacuum chamber. The RF bias can operate at a frequency of about 13.56 MHz. The etch process is discontinued based on an endpoint detection system such as an etch endpoint trace monitored at a specific wavelength, e.g., 387 nm, by an optical emission spectroscopy system. Upon completion of the etch process, the substrate is removed from the vacuum chamber and the mask layer is stripped from the substrate.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1A is a pictorial representation of a GST test structure before etch;

FIG. 1B is a pictorial representation of a GST test structure after etch;

FIG. 2 is a scanning electron microscopy photograph of an individual GST test structure on a substrate that has been etched using a BCl₃/Cl₂ gas mixture in accordance with the present invention;

FIG. 3 is a scanning electron microscopy photograph of several GST test structures on a substrate that have been etched using a BCl₃/Cl₂ gas mixture in accordance with the present invention;

FIG. 4 is a scanning electron microscopy photograph of several GST test structures on a substrate that have been etched using an Ar/Cl₂ gas mixture in accordance with the present invention;

FIG. 5 is a scanning electron microscopy photograph of several GST test structures on a substrate that have been etched using a HBr/Cl₂ gas mixture in accordance with the present invention; and

FIG. 6 shows an etch endpoint trace for the structure from FIG. 1B monitoring at 387 nm.

Similar reference characters refer to similar parts throughout the several views of the drawings.

### DETAILED DESCRIPTION OF THE INVENTION

We disclose an improved method for using a chlorine containing plasma for etching structures that have a chalcogenide layer, such as Ge₂Sb₂Te₅ (GST), that are used in the formation of memory devices such as Ovonic Unified Memory (OUM).

In order to determine an appropriate etch chemistry, it is often useful to look at the normal boiling points of potential etch products. Table 1 shows the potential etch products of Ge₂Sb₂Te₅ in fluorine, chlorine, bromine, and hydrogen-based chemistries. Lower normal boiling points indicate a more volatile (desirable) etch product.

Based on etch product volatility, fluorine, chlorine, bromine and hydrogen will all potentially form volatile etch products.

TABLE 1
Normal Boiling Point Data

| | Normal Boiling Point |
|---|---|
| Compound | (° C.) |
| GeBr₂ | 122 |
| GeBr₄ | 26 |
| GeCl₄ | −49 |
| GeF₄ | −37 |
| GeH₄ | −165 |
| SbF₅ | 150 |
| SbF₃ | 319 |
| SbCl₃ | 283 |
| SbCl₅ | 79 |
| SbBr₃ | 280 |
| SbH₃ | −17 |
| TeBr₂ | 339 |
| TeBr₄ | 421 |
| TeCl₂ | 327 |
| TeCl₄ | 380 |
| TeF₆ | 35 |
| TeF₄ | 97 |
| H₂Te | −2 |

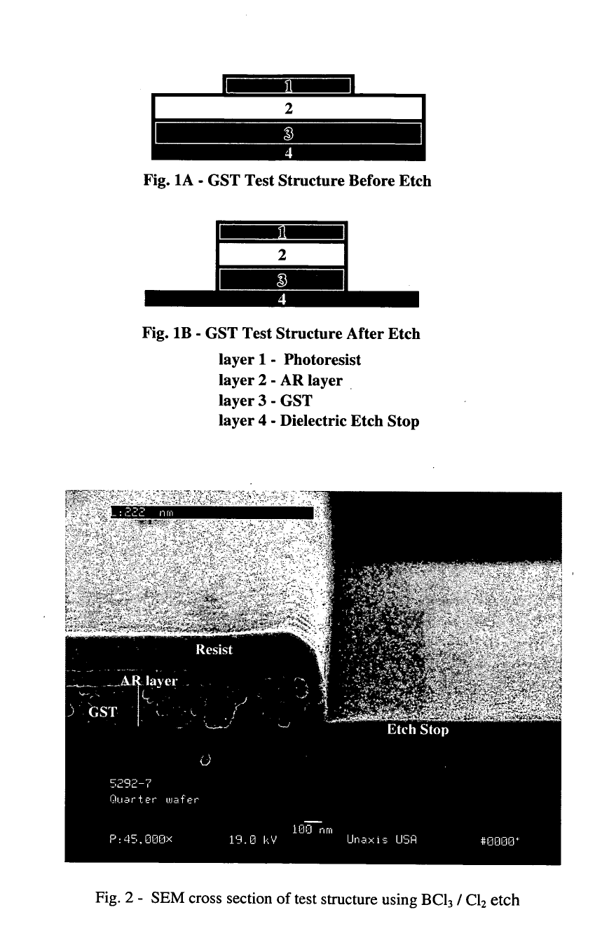

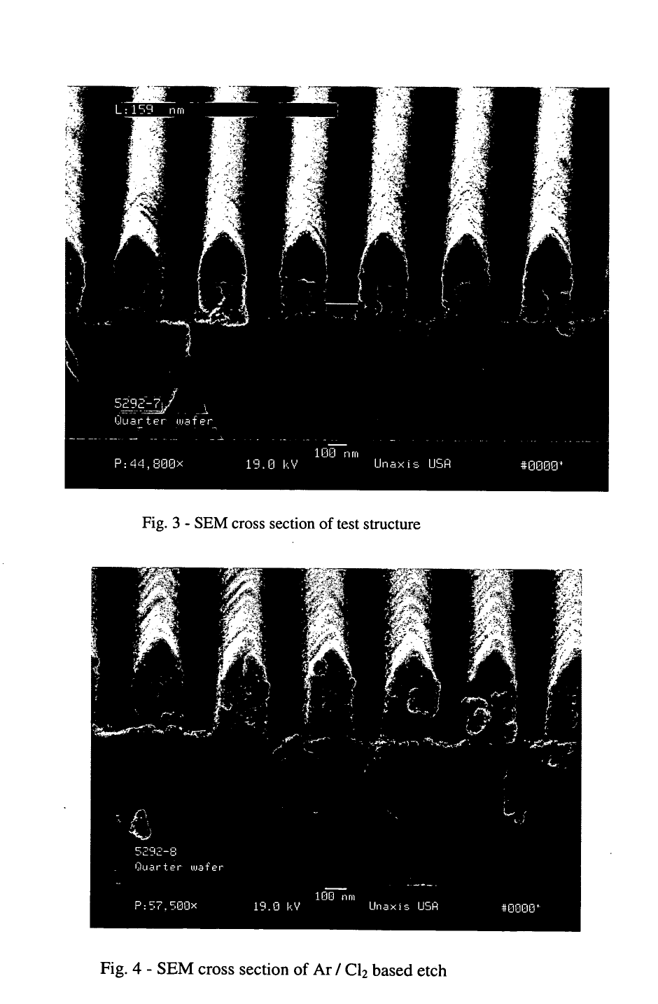

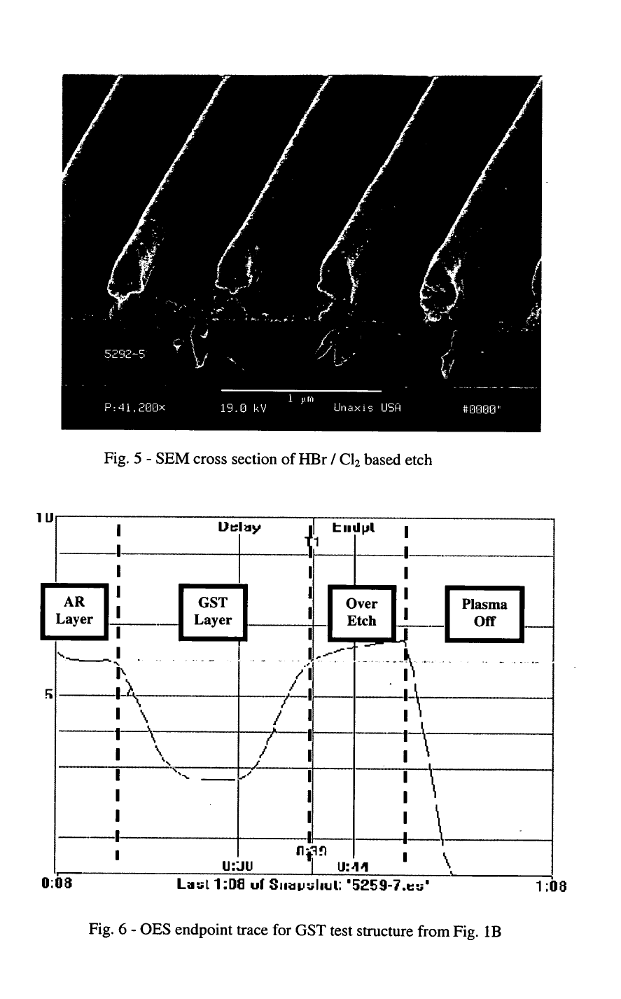

FIG. 1A shows the layers for a typical structure incorporating a chalcogenide, i.e., GST layer before the etch process. FIG. 1B shows a typical structure incorporating a GST layer after the anisotropic etch process of the present invention. The typical structure having a GST layer includes an anti-reflective (AR) layer between the photoresist mask (mask layer) and the GST layer with a dielectric etch stop (SiO₂, SiN, etc.) layer underneath the GST layer. In addition to anisotropically etching the GST layer, it is also desirable to use a single step process to anisotropically etch the AR layer and GST layer while at the same time maintaining a high etch selectivity between the GST layer and the final dielectric etch stop layer.

While hydrogen chemistries are acceptable for etching the GST layer with a high etch selectivity to the underlying dielectric etch stop layer, hydrogen alone is typically very inefficient for etching the AR layer.

Fluorine based chemistries will etch the GST layer and AR layer, but will typically exhibit poor etch selectivity to the underlying dielectric etch stop layer.

Chlorine based chemistries are capable of anisotropically etching the AR layer and GST layer with acceptable etch selectivity to the dielectric etch stop layer. Note, gas mixtures of chlorine and hydrogen (H₂ addition, HCl, etc.) will also provide good etch results. Oxygen scavengers (such as BCl₃ and SiCl₄) can also be added to the process gas mixture to help smooth the etch surface morphology as well as contributing to etch anisotropy through sidewall passivation.

An HBr/Cl₂ process has also been shown capable of etching the AR layer and GST layer. An Ar/Cl₂ process has also been shown capable of etching the AR layer and GST layer.

### EXAMPLE

System Description

Initial Experiments performed on a commercially available Unaxis SLR 770 Etcher. This reactor uses a 2 MHz ICP source to generate a high density plasma. Ion energy at the substrate (wafer) is controlled by independently biasing the cathode at 13.56 MHz. Wafer temperature is regulated by mechanically clamping the wafer to a liquid cooled cathode in conjunction with He backside cooling. Process endpoint experiments utilized a commercially available Unaxis Spectraworks optical emission system (OES).

Experimental Results:

The test structure shown in FIG. 1B was etched using the following process:

| | |
|---|---|
| BCl₃ | 10 sccm |
| Cl₂ | 20 sccm |
| Pressure | 5 mtorr |
| RF Bias | 50 W |
| ICP Power | 800 W |

This process results in:

| GST Etch Rate | 4000 Å/minute |
|---|---|
| Photoresist Etch Rate | 1860 Å/minute |
| Dielectric Etch Stop Rate | 500 Å/minute |
| GST: Photoresist | 2.2:1 |
| GST:Dielectric Etch Stop | 8:1 |

FIG. 2 shows a scanning electron microscopy (SEM) photograph of the cross section of a single test structure where a BCl₃/Cl₂ process gas has been used to plasma etch the GST layer and AR layer to the underlying dielectric etch stop layer.

FIG. 3 shows a SEM photograph of the cross section of several of the same test structure of FIG. 2 where a BCl₃/Cl₂ process gas has been used to plasma etch the GST layer and AR layer to the underlying dielectric etch stop layer.

FIG. 4 shows a SEM of the cross section of several of the same test structures of FIGS. 2 and 3 where a Ar/Cl₂ process gas has been used to plasma etch the GST layer and AR layer to the underlying dielectric etch stop layer.

FIG. 5 shows a SEM of the cross section of several of the same test structures of FIGS. 2-4 where a HBr/Cl₂ process gas has been used to plasma etch the GST layer and AR layer to the underlying dielectric etch stop layer.

In order to minimize the loss of the dielectric etch stop during overetch, it is also desirable to detect when the etch process has reached the GST:Etch Stop interface. Through the use of optical emission spectroscopy, it is possible to detect when the etch has reached the GST:Etch Stop interface. FIG. 6 shows an etch endpoint trace for the structure from FIG. 1B where the etch stop is SiN monitoring at 387 nm.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

1. An improved method for forming a memory element, the method comprising the steps of:
placing a substrate in a vacuum chamber, said substrate having a dielectric etch stop layer, a chalcogenide layer, an anti-reflective layer and a mask layer;
introducing at least one chlorine containing gas into the vacuum chamber;
igniting a high density plasma in the vacuum chamber;
etching said chalcogenide layer and said anti-reflective layer to expose said dielectric etch stop layer on said substrate;
removing said substrate from the vacuum chamber; and
stripping said mask layer from said substrate.

2. The method of claim 1 wherein said chalcogenide layer comprises GeₓSb_{y}Te_{z}.

3. The method of claim 2 wherein said GeₓSb_{y}Te_{z} is Ge₂Sb₂Te₅.

4. The method of claim 1 further comprising the step of supplying a bias to the substrate within the vacuum chamber.

5. The method of claim 4 wherein said bias is an RF bias operating at a frequency of about 13.56 MHz.

6. The method of claim 1 wherein said high density plasma source is an inductively coupled plasma source.

7. The method of claim 6 wherein said inductively coupled plasma source has a frequency of about 2 MHz.

8. The method of claim 1 wherein said chlorine containing gas comprises a mixture of BCl₃ and Cl₂.

9. The method of claim 1 further comprising introducing a hydrogen containing gas.

10. The method of claim 1 further comprising introducing an oxygen scavenger gas.

11. An improved method for forming a memory element, the method comprising the steps of:
placing a substrate in a vacuum chamber, said substrate having a dielectric etch stop layer, a chalcogenide layer, an anti-reflective layer and a mask layer;
introducing at least one chlorine containing gas into the vacuum chamber;
igniting a high density plasma in the vacuum chamber;
etching said chalcogenide layer and said anti-reflective layer to expose said dielectric etch stop layer on said substrate;
discontinuing the etching step based on an endpoint detection system;
removing said substrate from the vacuum chamber; and
stripping said mask layer from said substrate.

12. The method of claim 11 wherein said endpoint detection system uses an etch endpoint trace monitored at a specific wavelength by an optical emission spectroscopy system.

13. The method of claim 11 wherein said chalcogenide layer comprises GeₓSb_{y}Te_{z}.

14. The method of claim 13 wherein said GeₓSb_{y}Te_{z} is Ge₂Sb₂Te₅.

15. The method of claim 11 further comprising the step of supplying a bias to the substrate within the vacuum chamber.

16. The method of claim 15 wherein said bias is an RF bias operating at a frequency of about 13.56 MHz.

17. The method of claim 11 wherein said high density plasma source is an inductively coupled plasma source.

18. The method of claim 17 wherein said inductively coupled plasma source has a frequency of about 2 MHz.

19. The method of claim 11 wherein said chlorine containing gas comprises a mixture of BCl₃ and Cl₂.

20. The method of claim 11 further comprising introducing a hydrogen containing gas.

21. The method of claim 11 further comprising introducing an oxygen scavenger gas.
